(19) United States
(12) Patent Application Publication
(10) Pub. No.: US 2006/0282344 A1
(43) Pub. Date: Dec. 14, 2006

(54) Tracking sales of alcoholic beverages at a venue

(76) Inventor: Leetha Brown, Versailles, KY (US)

Correspondence Address: KING & SCHICKLI, PLLC, 247 NORTH BROADWAY, LEXINGTON, KY, 40507, US

(21) Appl. No.: 11/373,893

(22) Filed: Mar. 13, 2006

Related U.S. Application Data
(60) Provisional application No. 60/685,665, filed on May 27, 2005.

(51) Int. Cl. G07B 17/00

(52) U.S. Cl. 705/28; 705/30

(57) ABSTRACT

Methods and systems for tracking a sale of an alcoholic beverage to an individual at a venue includes personalized information, such as height, weight, age, prescription medicines, etc., tied to a local or remote identifier of the individual. During use, the individual presents the identifier to an operator at the venue so that the personalized information can be accessed. In one instance, this includes the further accessing of a database of records. Once obtained, and in comparison to specifics about the type, volume, alcohol content, etc. of the alcoholic beverage, it is determined whether consumption of the alcoholic beverage will cause the individual to become intoxicated, especially according to a standard measurement, such as a blood alcohol content of the individual based on a formula. The denying or consummating of the sale occurs thereafter as does the updating of the personalized information and/or database of records.

This application claims priority and benefit of U.S. Provisional Patent Application Ser. No. 60/685,665 entitled “Method for Providing Warnings as to the Potential Impairment of Purchasers of Intoxicating Beverages based upon Recent Purchases of Alcohol,” filed on May 27, 2005.

### FIELD OF THE INVENTION

Generally, the present invention relates to the sale of alcoholic beverages. Particularly, it relates to tracking sales at venues to ultimately monitor individual consumption. In one aspect, the invention contemplates methods and systems for tracking the purchase of alcoholic beverages by individuals in restaurants, bars, sporting complexes, and from other vendors where the beverage is intended for immediate consumption. In other aspects, the invention contemplates methods and systems for tracking the purchase of alcoholic beverages as a function of personalized information of the individual seeking to make the purchase. Other aspects, to name a few, contemplate individual identifiers, database(s) of records, communication environments, tracking underage sales and alcoholic beverage specifics.

### BACKGROUND OF THE INVENTION

There is a long felt need for better control over the sale of alcoholic beverages. Each year, thousands of people die at the hands of drunk drivers. This carnage is somewhat preventable and occurs mainly because people, once they start drinking, lose the ability to accurately judge when they are too impaired to drive. While many times the individual who drinks too much does so without the assistance of others, such is not the case when the beverage is purchased as a readily consumable beverage at a bar, restaurant, or similar setting. Indeed, many state legislatures and courts have enacted and enforced statutes which hold the seller of the alcoholic beverage at fault where they knew or should have known that the purchaser or ultimate consumer of the beverage was already intoxicated.

While the legislatures and courts have addressed the culpability of vendors of alcoholic beverages, this has done little to stem the tide of drunken driving accidents. In one regard, the problem lies in the fact that the victims of the drunken driver have a formidable task in finding a way to prove that the seller of the alcoholic beverage knew or should have known that the ultimate consumer of the beverage was already impaired. The courts and legislatures, while making a good attempt to discourage such activity, have not solved the problem and failed to address the problem of the situation where a patron of such establishments is not yet visibly impaired but legally intoxicated or when one more drink will be one too many. The key is then to prevent the sale of the alcoholic beverages to patrons who are either impaired, but not impaired to the visual perception of others, or would be impaired upon the consumption of one additional drink.

It is noted that some establishments have purchased breathalyzers in an attempt to help ascertain when patrons are too drunk to drive, but a patron cannot be forced to submit to such a test and too much discretion is left to the establishment over if and when to make a request to patrons. This method also would be rather offensive to patrons thus there is an economic advantage to establishments that do not employ such measures.

Accordingly, a need exists in the field of tracking alcohol sales to do so less intrusively and more definitively. Naturally, any improvements should further contemplate good business practices, such as relative inexpensiveness, ease of implementation, low complexity, etc.

In a related field, the dispensation of narcotics has been successfully tracked through the use of patient identifiers and an on-line database. Generally, this system helps prevent the dispensation of illegal prescriptions and suspicious sale quantities of narcotics in an attempt to prevent, not discourage, drug abuse. A similar system would be most beneficial in the fight against alcohol abuse and would allow the drinks consumed at other establishments to be tracked and used to help control the abuse of alcohol.

### SUMMARY OF THE INVENTION

The above-mentioned and other problems become solved by applying the principles and teachings associated with the hereinafter described methods and systems for tracking the sale of alcoholic beverages at a venue.

In one aspect, the sale tracking of an alcoholic beverage to an individual at a venue includes personalized information, such as height, weight, age, prescription medicines, etc., tied to a local or remote identifier of the individual. During use, the individual presents the identifier to an operator at the venue so that the personalized information can be accessed. In one instance, this includes the further accessing of a database of records. Once obtained, and in comparison to specifics about the type, volume, alcohol content, etc. of the alcoholic beverage, it is determined whether consumption of the to-be-sold alcoholic beverage will cause the individual to become intoxicated, especially according to a standard measurement, such as a blood alcohol content of the individual based on the Widmark formula. The denying or consummating of the sale occurs thereafter. For robustness, the personalized information and/or database of records is fairly immediately updated as it relates to the sold or denied-sale of the beverage. In other aspects, the system includes varieties of communication and point of sale devices and inputting of information. Still other aspects describe individual identifiers or personalized information, database(s) of records, communication environments, and alcoholic beverage specifics.

These and other embodiments, aspects, advantages, and features of the present invention will be set forth in the description which follows, and in part will become apparent to those of ordinary skill in the art by reference to the following description of the invention and referenced drawings or by practice of the invention. The aspects, advantages, and features of the invention are realized and attained by means of the instrumentalities, procedures, and combinations particularly pointed out in the appended claims.

### BRIEF DESCRIPTION OF THE DRAWINGS

The accompanying drawings incorporated in and forming a part of the specification, illustrate several aspects of the present invention, and together with the description serve to explain the principles of the invention. In the drawings:

FIG. 1 is a diagrammatic view in accordance with the present invention of a representative environment for tracking sales of alcoholic beverages at a venue;

FIG. 2 is a diagrammatic view in accordance with the present invention of a representative environment for tracking sales of alcoholic beverages for use in addition to or in lieu of the environment of FIG. 1;

FIG. 3A is a diagrammatic view in accordance with the present invention of a representative identifier for use in tracking sales of alcoholic beverages;

FIG. 3B is a diagrammatic view in accordance with the present invention of an alternate representative identifier for use in tracking sales of alcoholic beverages; and

FIG. 4 is a flow chart in accordance with the present invention of a representative method for tracking sales of alcoholic beverages.

### DETAILED DESCRIPTION OF THE PREFERRED EMBODIMENTS

In the following detailed description of the preferred embodiments, reference is made to the accompanying drawings that form a part hereof, and in which is shown by way of illustration, specific embodiments in which the invention may be practiced. These embodiments are described in sufficient detail to enable those skilled in the art to practice the invention, and it is to be understood that other embodiments may be utilized and that process, electrical, mechanical, communication and/or software changes may be made without departing from the scope of the present invention. In accordance with the present invention, methods and systems for tracking alcohol sales to an individual at a venue are hereinafter described.

Preliminarily, however, the present invention is a system and method for controlling the dispensation of alcoholic beverages for immediate consumption by tracking the purchase of such beverages by individuals. Standard calculations or measurements, such as the Widmark formula and the equation utilized by the U.S. Department of Transportation, are available to accurately determine the degree of intoxication based upon the amount of alcohol consumed over a given time period. In one instance, these equations are known as follows: Widmark formula=[(#of drinks)(# oz. ethanol/drink)(0.0514 lbs. ethanol/oz. ethanol)(1.055 g ethanol/ml)]/[(weight of person in lbs.)*Widmark “r” value]*100−(B*time) where “r” refers to the percentage of body mass of an individual that contains alcohol (total body mass−mass of fat and bone), and B is the hourly decrease in BAC; and the U.S. Department of Transportation formula=[(# of drinks)(# oz. ethanol/drink)(23.36 grams ethanol/oz.)(0.806 ml H₂O/ml blood)]/[(weight of person in lbs./2.2046 lb/kg)(TBW)(1000 g/kg)]*100−(B*time) where TBW refers to the total body water volume and B is the hourly decrease in BAC. Of course, the system can be made even more accurate by inclusion of body weight to help determine the rate at which the body rids itself of alcohol.

It is anticipated that accurate tracking can be achieved through the use of personal identification cards or other, such as drivers licenses or passports, which carry sufficient identification as to allow the purchaser to be successfully tracked from vendor to vendor and from state to state. Personal identification cards would also contain sufficient biometric information as to include body weight, height, and age. Warnings could conceivably be provided by the system when alcohol is purchased by diagnosed alcoholics, persons convicted of drunk driving, or minors. Additional warnings could be provided by the system if the purchaser is currently taking prescription medication which is contraindicated for use with alcohol due to side effects or synergism between them.

The data from the personal identification cards is expected to either be input by a personal identification number (PIN) such as a driver's license or social security number or from external agencies. The data could either be input manually or taken directly from the card by memory chip or bar code. The data would then be fed into a database so that the vendor could determine how many drinks the consumer had previously purchased and calculate their approximate blood alcohol content (BAC) based on the number of drinks, when they were purchased, and the biometric data of the purchaser. The system could provide the approximate BAC anticipated after consumption of additional beverages the consumer is attempting to buy and could conceivably calculate the anticipated degree of impairment based upon the effects of prescription medications that the consumer is known to be taking.

In an anticipated alternative embodiment, the data could be a PIN number or simply the social security number.

In a further anticipated alternative embodiment, the system is integrated with a cash register at a point of sale terminal.

In a further anticipated alternative embodiment, the system could utilize a combination of PIN or social security number with a fingerprint or thumb scan or iris or retina scan to verify the individual's identity. Radio frequency identification (RFID) is also contemplated.

In a further anticipated alternative embodiment, the system is integrated with the dispensing of alcohol so that the intoxicated patron cannot be served by the vendor should the vendor decide to ignore the system warnings.

The data for prescription drug use by potential consumers of alcoholic beverages is anticipated to be accessible from existing databases (e.g., KASPER) or may require the creation of a central database to be updated by vendors of pharmacologic compounds. The system could also provide informing the consumer and vendor of the physical and mental effects of impairment due to the alcohol and its continued consumption. It is anticipated that for maximum benefit the system will allow only one to two drinks maximum per purchase by an individual and that it is preferable that an individual purchase his or her own drinks.

The system is anticipated to be implemented through various software programs written in a variety of numerous programming languages. It is conceivable that much of the system could be assembled from pre-existing pieces of programming code or software packages by adapting them for the specific purpose of tracking the sale of alcoholic beverages to consumers.

The database could be accessible through direct connection or through secure connection through the internet, an intranet, or via an extranet. The database could be commercially maintained, be maintained by a government entity, or be maintained by a non-profit organization.

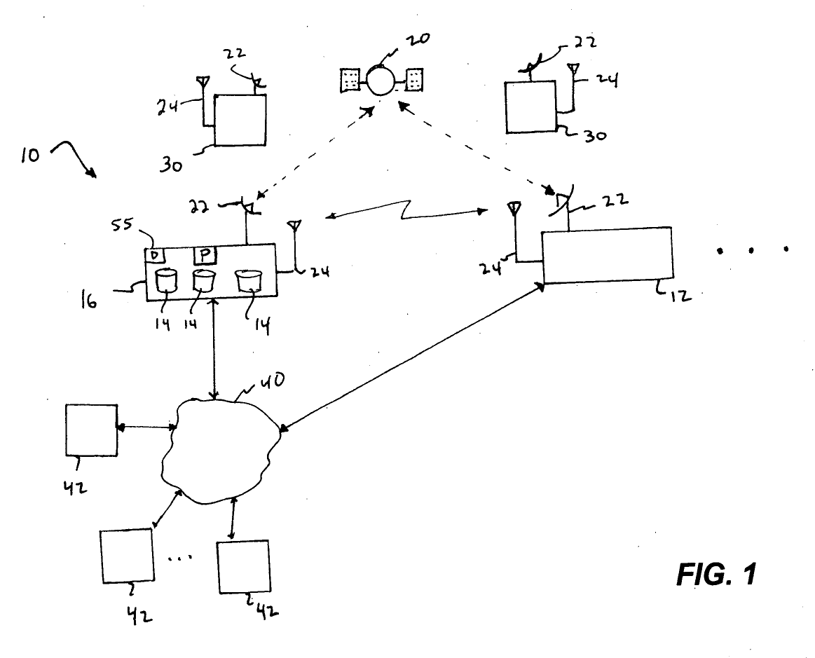

With reference to FIG. 1, an environment having utility in the context of tracking alcohol sales at a venue 12 is given generically as element 10. In this regard, the venue 12 includes wired or wireless communications with a database(s) of records 14 at a facility, such as a central facility 16. In the wireless aspect, one way or bi-directional communications occur via a satellite 20 and attendant satellite dishes 22, for example. Alternatively, or in addition, it includes line of sight or other communications between antennas 24. Of course, the communications may include AM, FM, PSK, QAM or other modulation schemes. Appreciating the environment 10 may be geographically large, one or more repeating stations 30 may also be positioned variously in establishing the communication schema. Of course, their operation is well known. In the wired aspect, the database(s) of records 14 connect to one or more network connections nebulously given as element 40. Coupled thereto, are various venues 12 engaged in the sale of alcoholic beverages to individuals. Also, other sources of information 42 for inputting information into the databases are contemplated. In this regard, the sources include foreign or domestic governmental agencies in control of driver license registrations. In another, it includes the United States (U.S.) Department of Homeland Security, the U.S. Federal Bureau of Investigation, the U.S. Central Intelligence Agency, etc. In still another, it includes health agencies, such as the U.S. National Institute of Health or local hospitals or doctor offices. In this way, patient or personalized information about the individual can be inputted into the database(s) of records. Types of information representatively include, an individual's height, weight, age, gender, race, medical prescriptions, medical history, personal or family illness history, felony or misdemeanor convictions or prosecutions, outstanding warrants, immigration status, etc. As will be seen below, this personalized information will then be used in determining whether an alcohol sale should occur at the venue.

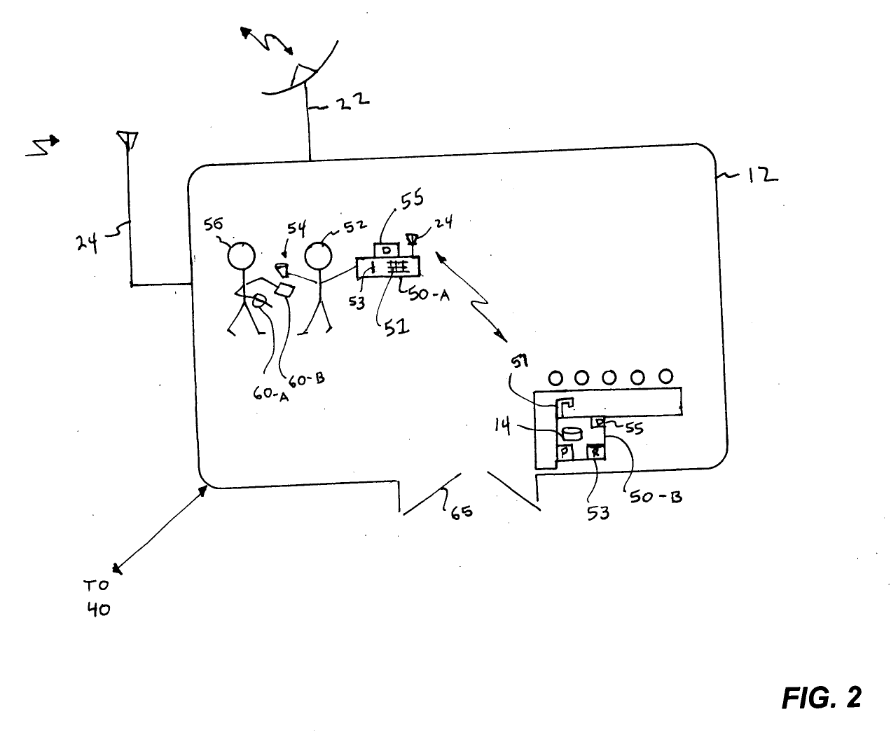

With reference to FIG. 2, a venue 12 of the invention representatively includes at least one point of sale terminal 50 for the sale of alcohol. In this regard, it may include an attendant cash register or a structure 57, such as a bar gun, for dispensing alcohol. In the embodiment given as terminal 50-A, an operator 52 carries the terminal around during the sales of alcohol beverage(s) 54 to an individual 56. In a representative would-be sale, the individual 56 requesting alcohol produces an identifier 60, of sorts, to make it known to the venue 12 who is requesting the alcohol. The identifier, as will be further described below, may be nationally issued as part of a driver's licensing program or locally issued, such as at the point of entry 65 to the venue. In either instance, the identifier directly or indirectly represents the personalized information, described above, of the individual. Directly, the personalized information is found directly on the identifier. Indirectly, the personalized information is communicated from the database(s) of records. In turn, the database(s) of records 14 may be at the central facility 16, FIG. 1, and/or be attendant at the venue 12, such as with another point of sale terminal 50-B or resident within the point of sale terminal 50-A. If in a database(s) of records, the personalized information may again be input by various sources 42, FIG. 1 or done at the time of an individual's entry at the point of entry 65. It may even be inputted, via input pad 51, at the point of sale occurring with terminal 50-A.

Regardless, the personalized information of the individual is ascertained. Then, in comparison to specifics about the alcohol beverage 54 attempted to be served, it is determined whether the individual's consumption of the alcoholic beverage 54 will cause the individual to become intoxicated. If so, the sale of the alcohol is denied. The structure 57, such as a bar gun, could also be programmed, in this regard, to prevent alcohol dispensing. If not, the sale of alcohol is consummated. Representative specifics about the alcoholic beverage include, but are not limited to, alcoholic content, the serving size amount, the brand, volume dispensed, or the like.

In another representative embodiment, the personalized information of the individual is ascertained via a variety of mechanisms. Namely, a point of sale terminal may include a reader 53, of sorts, such as a smart card reader, a bar code reader, a fingerprint or iris or retina scanner, a radio frequency identifier device (RFID) or the like. Also, a display, D, 55 is used to communicate visually with letters, numbers, etc. to the operator to provide warnings, status, or various communications indicative of the individual, especially their personalized information. Naturally, the point of sale terminals will likely also include one or more processors P to assist in this regard. They may even include label printers, for example, to create warnings placeable directly on the alcoholic beverage.

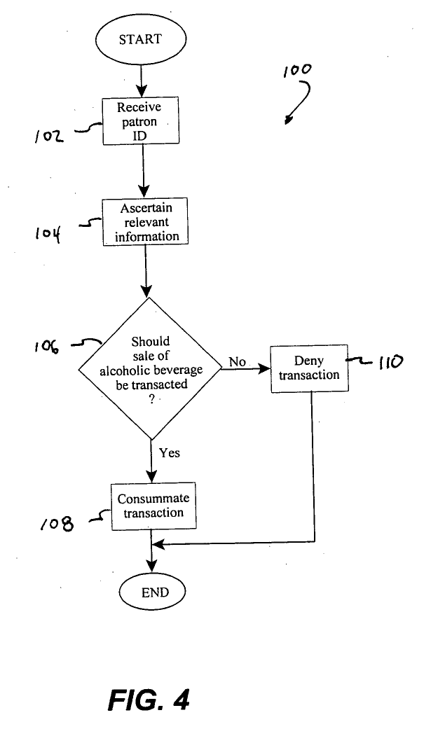

With reference to FIG. 4, the above methodology is given generally as 100. At step 102, the identifier of the individual patron seeking to purchase alcohol is received or obtained by the venue. The relevant personalized information of the identifier is then ascertained at step 104. Again, this may include reading directly the identifier and/or communicating with local or remotely database(s) of records 14. Once ascertained, it is determined whether the sale of alcoholic beverages should be transacted, step 106. Particularities of this step include calculating the Widmark formula or other standard intoxication measurement for a particular locale. Then, if it is determined that the sale should be transacted, the transaction is consummated at step 108. Otherwise, the sale is denied at step 110. Whether consummated or denied, the identifier and/or database of records can be updated by the venue. In a particular embodiment, the reverse of obtaining the personalized information is caused to occur. That is, transmitting instead of receiving, writing or transmitting to databases instead of reading or receiving, or the like.

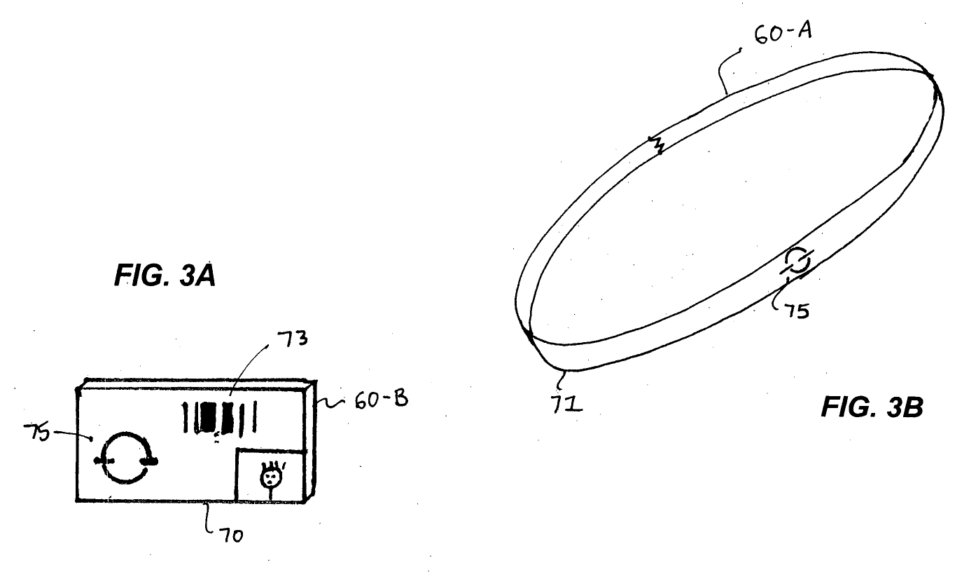

With reference to FIGS. 3A and 3B, identifiers 60 are detailed. In one instance, the identifier embodies either a card 70 or a bracelet 71. In either, personalized information is found such as an RFID tag or bar code 73, as part of a biometric analysis 75 on a smart chip, for example, via communication to a database of records or by other. In one instance, the biometric analysis includes a fingerprint, thumb, iris or retinal data of the individual that can be verified by at the time of purchasing an alcoholic beverage. In addition, the personalized information includes, but is not limited to, items such as the individual's height, weight, age, prescription medicines, etc. Also, the embodiment of the bracelet may include convenient mechanical structures 77, such as clasps, hinges, tape, etc. to facilitate size adjustments and/or fashioning about a wrist. Tracking devices, not shown, may also be used to help individual's located lost, stolen or otherwise misplaced identifiers. Alternatively, the smart chip, RFID or other may be used in helping tracking.

Finally, one of ordinary skill in the art will recognize that additional embodiments are also possible without departing from the teachings of the present invention. For example, combinations of the foregoing embodiments are greatly embraced by the invention as are other known or hereinafter contemplated communication systems. This detailed description then, and particularly the specific details of the exemplary embodiments disclosed herein, is given primarily for clarity of understanding, and no unnecessary limitations are to be understood therefrom, for modifications will become obvious to those skilled in the art upon reading this disclosure and may be made without departing from the spirit or scope of the invention.

What is claimed:

1. A method for tracking a sale of an alcoholic beverage to an individual at a venue, comprising:
ascertaining personalized information of the individual;
based upon the personalized information, determining whether consumption of the alcoholic beverage will cause the individual to become intoxicated; and
based upon the determining, denying or consummating the sale.

2. The method of claim 1, wherein the ascertaining the personalized information further includes communicating with a database of records.

3. The method of claim 2, wherein the communicating with the database of records is further performed locally or remotely.

4. The method of claim 3, wherein the ascertaining the personalized information further includes communicating with an identifier of the individual.

5. The method of claim 1, wherein the determining further includes inputting specifics about the alcoholic beverage into a terminal or bar gun.

6. The method of claim 5, further including utilizing the specifics about the alcoholic beverage relative to the personalized information and calculating a standard intoxication measurement.

7. The method of claim 1, further including obtaining an identifier of the individual, the ascertaining being related to the identifier.

8. The method of claim 1, further including updating the personalized information after a consummated or denied sale.

9. The method of claim 1, further including comparing the personalized information against a prescription drug dispensation for the individual.

10. The method of claim 9, further including warning of a dangerous drug interaction between the alcoholic beverage and a prescription drug of the dispensation.

11. The method of claim 1, further including inputting the personalized information into a database of records from a location remote from the venue.

12. A method for tracking a sale of an alcoholic beverage to an individual at a venue, comprising:
enabling access to a database of records;
obtaining an identifier of the individual;
after the obtaining the identifier, ascertaining personalized information of the individual from the identifier or the database of records;
based upon the personalized information, determining whether consumption of the alcoholic beverage will cause the individual to become intoxicated;
based upon the determining, denying or consummating the sale; and
thereafter, updating the identifier or the database of records.

13. The method of claim 12, further includes inputting specifics about the alcoholic beverage into a terminal.

14. The method of claim 13, further including utilizing the specifics about the alcoholic beverage relative to the personalized information and calculating a standard intoxication measurement.

15. The method of claim 12, further including comparing the personalized information against a prescription drug dispensation for the individual.

16. The method of claim 15, further including warning of a dangerous drug interaction between the alcoholic beverage and a prescription drug of the dispensation.

17. The method of claim 12, wherein the obtaining the identifier further includes scanning a fingerprint or an iris of the individual.

18. The method of claim 12, wherein the obtaining the identifier further includes reading stored values in a smart chip or communicating with an RFID.

19. A system for tracking a sale of an alcoholic beverage to an individual at a venue, comprising:
an identifier of the individual;
a point of sale terminal for ascertaining personalized information of the individual from the identifier; and
a processor for calculating whether consumption of the alcoholic beverage by the individual will cause the individual to become intoxicated.

20. The system of claim 19, further including a database of records communicating with the point of sale terminal via the functionality of the identifier, the point of sale terminal further including a display for indicating status to an operator at the venue.
